(19) United States
(12) Patent Application Publication
(10) Pub. No.: US 2024/0240074 A1
(43) Pub. Date: Jul. 18, 2024

(54) COMPOSITIONS FOR STIMULATION OPERATIONS

(71) Applicant: Saudi Arabian Oil Company, Dhahran (SA)

(72) Inventors: Rajesh Kumar SAINI, Cypress, TX (US); Mohammed SAYED, Katy, TX (US)

(73) Assignee: Saudi Arabian Oil Company, Dhahran (SA)

(21) Appl. No.: 18/155,430

(22) Filed: Jan. 17, 2023

(51) Int. Cl. C09K 8/86; C09K 8/60; C09K 8/74; C09K 8/94

(52) U.S. Cl. CPC C09K 8/86; C09K 8/602; C09K 8/74; C09K 8/94

(57) ABSTRACT

Compositions for stimulating a subterranean formation may include 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the composition, excluding aqueous fluids. The compositions may be combined with an aqueous fluid, optionally to form foams or emulsions.

### FIELD OF THE DISCLOSURE

The present disclosure relates generally to hydrocarbon reservoir stimulation.

### BACKGROUND OF THE DISCLOSURE

Reservoir stimulation may be performed on a subterranean reservoir to achieve, increase, or restore fluid production therefrom, such as hydrocarbons including oil and gas. Reservoir stimulation operations include matrix acidizing, fracturing, and acid fracturing as non-limiting examples. The type of stimulation operation employed in a particular circumstance may depend on factors including the geology of the formation and the type of hydrocarbons being produced.

Reservoirs targeted for stimulation operations may include moderate- to low-permeability carbonate reservoirs, typically comprising calcite and/or dolomite, optionally in combination with other minerals. Tight carbonate reservoirs may exhibit high temperatures, low to medium porosity, variable reservoir properties, and highly heterogeneous lithology. Tight carbonate reservoirs may benefit greatly from stimulation operations, such as matrix acidizing or acid fracturing, to increase production therefrom. During matrix acidizing operations, mineral acids or organic acids are used to dissolve a portion of the carbonate matrix to form passages (wormholes) through which a hydrocarbon resource may flow. Matrix acidizing operations are conducted below the fracture gradient pressure (i.e., the pressure above which injection of fluids will cause a formation to fracture hydraulically) of the carbonate reservoir. Acid fracturing is conducted above the fracture gradient pressure of the carbonate reservoir to create or extend a plurality of fractures into the carbonate matrix, which may be held open by proppant particulates once the pressure is released. The acid may continue to erode the fractures or expand wormholes extending therefrom to increase production.

A high-density calcium or magnesium brine may be formed as a result of dissolution of the carbonate matrix during matrix acidizing or acid fracturing. The brine may take a considerable time to flow back to the surface due to its density, and a considerable volume (e.g., 60-90% in tight carbonate formations) of the stimulation fluid introduced to the reservoir may remain downhole. The brine may block wormholes and pore space within the carbonate reservoir and limit production by impeding the flow of oil or gas therethrough. Limited brine production may be especially problematic in low-pressure carbonate reservoirs and reservoirs containing multi-lateral wells.

Foaming may be utilized to facilitate production of stimulation fluids following an acidizing operation or an acid fracturing operation. Gases suitable for promoting foam formation within a stimulation fluid include, for example, nitrogen or carbon dioxide. A polymer may be present to facilitate the foaming process. However, excessive polymer loading within a stimulation fluid may result in plugging the porosity within the carbonate reservoir. Moreover, high surface tension (interfacial tension) values resulting from use of a polymer may limit fluid production as well.

Another approach for facilitating production following a stimulation operation is to utilize a microemulsion containing one or more surfactants during the stimulation operation. The microemulsion may decrease surface tension and modify the contact angle within the carbonate reservoir, thereby allowing production to take place more easily. Unfortunately, surfactant chemistry is not universally compatible with the conditions typically encountered in all carbonate reservoirs. For example, some surfactants may not promote emulsification at the high temperatures found in many carbonate reservoirs. Moreover, many surfactants are incompatible with the acids used during stimulation, and some surfactants are incompatible with each other when blended together. Large volumes of stimulation fluid may be needed in many instances to account for the decreased surfactant performance resulting from surfactant incompatibility or degradation.

In view of the foregoing, stimulation fluids exhibiting enhanced production following introduction to a carbonate reservoir are highly desired.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Non-limiting example compositions of the present disclosure may comprise: 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the composition, excluding aqueous fluids. Optionally, the compositions may further include an aqueous fluid.

Non-limiting example methods of the present disclosure may comprise: providing a treatment fluid comprising: an aqueous fluid comprising an aqueous acid selected from the group consisting of a mineral acid, an organic acid, and any combination thereof; 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the treatment fluid, excluding aqueous fluids; and introducing the treatment fluid into a subterranean formation during a stimulation operation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIGS. 1A and 1B are graphs of fluid recovery as a function of time for Samples A-F at 2 gpt and 5 gpt, respectively.

### DETAILED DESCRIPTION

Embodiments in accordance with the present disclosure generally relate to hydrocarbon reservoir stimulation.

Compositions of the present disclosure may provide advantages over those conventionally used in subterranean stimulation operations, including increased stability to temperature and acidic conditions, improved formation permeability, increased recovery of hydrocarbons following stimulation, increased production of spent stimulation fluid, retardation of acid activity (matrix dissolution rate) to afford more feasible use and deeper matrix penetration during stimulation, and decreased treatment fluid volumes during stimulation, which may afford various economic and environmental advantages. Compositions of the present disclosure may comprise a blend of components that accomplish one or more of the foregoing once combined with an aqueous acid and introduced to a carbonate reservoir. Advantageously, the blend of components may be pre-formulated for later combination on an as-needed basis with an appropriate aqueous acid to perform a desired type of stimulation operation in a given carbonate reservoir. Additional details regarding the various components that may be present in the compositions of the present disclosure, as well as aqueous acids or other aqueous fluids suitable for combining therewith, are specified below.

Advantageously, the various surfactants present within the compositions are compatible with each other, thus allowing a blend of the various components to be pre-formulated together prior to being combined with an aqueous acid or other aqueous fluid. Moreover, once combined with an aqueous acid, the compositions of the present disclosure may maintain stability at temperatures up to 200° F. to 350° F. for at least 24 hours of contact time before spending of the acid takes place and for at least 72 hours of contact time in spent acid. Stability may be assessed by sampling and visual inspection of the compositions after exposure to conditions potentially promoting instability. Phase separation may be indicative of instability. Alternately, changes in surface tension may be indicative of instability.

The compositions of the present disclosure may advantageously form microemulsions when formulated as a treatment fluid, which may facilitate their use in subterranean treatment operations, such as stimulation of a carbonate reservoir. Advantageously, the emulsions may maintain stability under a wide range of conditions commonly encountered in a carbonate reservoir. Low surface tension values (e.g., about 31 mN/m or less, as measured against air) may be realized as well, which may likewise facilitate introduction to and production from a subterranean formation. In addition, the compositions of the present disclosure may be foamed, if desired. All of the foregoing may aid in promoting fluid recovery once a stimulation operation has taken place.

Without being limited by theory or mechanism, low surface tension values are believed to afford decreased capillary pressure within a subterranean formation. Decreased capillary pressure, in turn, may allow for improved fluid recovery (flowback) of the composition or a spent variant thereof through a reduction in the force needed to promote fluid flow within a subterranean formation. As used herein, capillary pressure may be calculated according to Equation 1 below

$${P}_{c} = \frac{γcos ( θ )}{d} \qquad Equation 1$$

where γ is the surface tension of the composition in mN/m or Dyne/cm relative to air, cos(0) is the cosine of contact angle between the rock, fluid and gas, and d is the diameter of pores in mm. The unit of capillary pressure Pc is Pascal. When introduced to a subterranean formation, the compositions of the present disclosure may mitigate or eliminate the formation of water blocks, which may otherwise obstruct flow back to the wellhead.

As a further advantage, the compositions of the present disclosure may undergo limited emulsion formation with hydrocarbons (condensate) within a wellbore. That is, the compositions may be readily introduced to a subterranean formation in emulsified form and once contacted with condensate, the emulsion may break. Spontaneous breaking of the emulsions under the subterranean conditions may facilitate production of hydrocarbons from the formation, whereas production of an emulsion may be more difficult and require extensive processing to recover the hydrocarbons therefrom. In addition, this feature may facilitate more efficient usage of the compositions to promote stimulation downhole.

Compositions of the present disclosure may comprise an oleaginous liquid; a fatty alkyl alcohol ethoxylate; at least one of a fatty alkyl ethoxylated ammonium salt (a cationic surfactant), a zwitterionic surfactant, an alkyl ether sulfate salt (an anionic surfactant), or an alkyl ether sulfonate salt (an anionic surfactant); and a co-solvent (or mixture of co-solvents). Suitable examples of these components are discussed in further detail below. In more particular examples, compositions of the present disclosure may comprise 10 wt % to 25 wt % of the oleaginous liquid, 5 wt % to 50 wt % of the fatty alkyl alcohol ethoxylate, 15 wt % to 75 wt % of at least one of the fatty alkyl ethoxylated ammonium salt, the zwitterionic surfactant, the alkyl ether sulfate salt, or the alkyl ether sulfonate salt, and 5 wt % to 40 wt % of the co-solvent, each wt % being based on a total mass of the composition, excluding aqueous fluids. In still more particular examples, compositions of the present disclosure may comprise 15 wt % to 20 wt % of the oleaginous liquid, 10 wt % to 40 wt % of the fatty alkyl alcohol ethoxylate, 20 wt % to 60 wt % of at least one of the fatty alkyl ethoxylated ammonium salt, the zwitterionic surfactant, the alkyl ether sulfate salt, or the alkyl ether sulfonate salt, and 10 wt % to 30 wt % of the co-solvent.

Suitable oleaginous liquids may promote formation of an oil-in-water emulsion when the compositions are mixed with an aqueous fluid in combination with other components. Double or triple emulsions may also be formed. Suitable oleaginous liquids include, for example, terpenes (e.g., D-limonene, lemon oil, pine oil, and the like), hydrocarbons (e.g., toluene, xylene, diesel, mineral oil, and the like), fatty alkyl esters, and the like. Suitable fatty alkyl esters may include a C₆-C₃₀ fatty acid component and a C₁-C₂₄, or C₁-C₁₂, or C₁-C₆ alcohol components, such as a methyl ester of a C₆-C₃₀ fatty acid. Examples of suitable oleaginous liquids include HFS-10 (available from EVALANCE) or STEPAN® C-25 and C-65 (available from the Stepan Company).

Suitable fatty alkyl alcohol ethoxylates may comprise a linear or branched C₆-C₁₈ alcohol ethoxylate comprising 3 to 30 ethoxylate repeat units. The fatty alcohol may be a primary, secondary, or tertiary alcohol, with the ethoxylate repeat units extending from the alcohol group. Example fatty alcohol ethoxylates include TERGITOL™ 15-S-7 and 15-S-9 (available from Dow Chemical), BIO-SOFT®N91-6 (available from the Stepan Company). When combined with an aqueous fluid in combination with other components, the fatty alcohol ethoxylate may serve as a neutral surfactant and decrease surface tension of the compositions.

In some embodiments, the compositions may comprise at least the fatty alkyl ethoxyalted ammonium salt. Suitable fatty alkyl ethoxylated ammonium salts may comprise at least one functionalized alkyl group comprising 3 to 30 ethoxylate repeat units. In non-limiting examples, suitable ethoxylated ammonium salts may comprise one or two functionalized alkyl groups comprising 3 to 30 ethoxylate repeat units and two or three linear or branched C₁-C₂₄ alkyl groups. Such ethoxylated ammonium salts may function as a cationic surfactant when the compositions are combined with an aqueous fluid in combination with other components. Example ethoxylated ammonium salts include, for example, ETHOQUAD® C/25 (available from Nouryon) (cocoalkylmethyl[polyoxyethylene (15)] ammonium chloride).

In some embodiments, the compositions may comprise at least the zwitterionic surfactant. Suitable zwitterionic surfactants may include betaines and sultaines. The zwitterionic surfactant may be selected in order to convey stability of the compositions toward high temperatures (greater than 200° F.), high saline environments (greater than 5 wt % total dissolved solids), and low pH values (pH of 3 or less). Suitable zwitterionic surfactants may comprise C₁₂-C₁₈ betaines, which may comprise a positively charged amine group and a negatively charged carboxylate group. Zwitterionic surfactants of these types may include cocoamidopropyl betaine, laurylamidopropyl betaine, and the like. Suitable zwitterionic surfactants may also comprise C₁₂-C₁₈ sultaines, which may comprise a positively charged amine group and a negatively charged sulfonic acid group. Zwitterionic surfactants of these types may include lauramidopropyl hydroxysultaine, cocoamido hydroxysultaine, tallowamidopropyl hydroxysultaine, and the like. Example zwitterionic surfactants that are betaines include PETROSTEP® B-1235 and PETROSTEP® LME-50 (available from the Stepan Company).

In some embodiments, the compositions may comprise at least the alkyl ether sulfate salt or the alkyl ether sulfonate salt, preferably an alkyl ether sulfate ammonium salt or an alkyl ether sulfonate ammonium salt. Alkali metal salts of alkyl ether sulfates or alkyl ether sulfonates may also be suitable. These types of compounds are anionic surfactants. Suitable alkyl ether sulfate or sulfonate salts may comprise a linear or branched C₆-C₁₈ alcohol reacted with 2 to 30 ethoxylate repeat units, with the terminal alcohol group functionalized with a sulfate or sulfonate head group. A cation, preferably ammonium, may balance the charge of the sulfate or sulfonate head group. Example alkyl ether sulfate salts and alkyl ether sulfonate salts of these types include PETROSTEP® ES-65A (available from the Stepan Company) and alpha olefin sulfonate ethers.

More than one surfactant selected from the fatty alkyl ethoxylated ammonium salt, the zwitterionic surfactant, the alkyl ether sulfate salt, or the alkyl ether sulfonate salt may be present in some cases. For example, the compositions may comprise at least two of the fatty alkyl ethoxylated ammonium salt, the zwitterionic surfactant, the alkyl ether sulfate salt, or the alkyl ether sulfonate salt, wherein at least two different types of surfactants are chosen from among the selected groups (e.g., a fatty alkyl ethoxylated ammonium salt and a zwitterionic surfactant, or a fatty alkyl ethoxylate ammonium salt and an alkyl ether sulfate salt or an alkyl ether sulfonate salt).

Suitable co-solvents include short-chain monohydric, dihydric, or polyhydric alcohols, esterified or partially esterified forms thereof, or etherified or partially etherified forms thereof, which may be miscible, immiscible, or partially immiscible with water. The co-solvent may aid in solvating various components of the compositions, optionally further aided by the oleaginous liquid. Suitable co-solvents may include alcohols, glycols, glycol ethers, and glycol esters. In more specific examples, suitable co-solvents may preferably have an alkyl chain length of C₃-C₈. Example co-solvents that may be suitable include, for instance, methanol, ethanol, isopropanol, butanol, ethylene glycol, propylene glycol, propylene glycol methyl ether, and the like.

The foregoing components may be provided as a blend, which may be stored for further use or immediately combined with an aqueous fluid. If not blended with an aqueous fluid, the compositions may comprise a non-aqueous solution of the various components above. In further embodiments, the compositions of the present disclosure may further comprise an aqueous fluid. When comprising an aqueous fluid, the compositions of the present disclosure may be emulsified or non-emulsified, depending on the conditions to which the compositions are exposed. Preferably, compositions comprising an aqueous fluid are emulsified.

Suitable aqueous fluids for inclusion in the compositions may include, but are not limited to, fresh water (e.g., stream water, lake water, or municipal treated water), non-potable water such as gray water or industrial process water, sea water, brine, aqueous salt solutions, partially desalinated water, produced water (including brine and other salt water solutions), or any combination thereof. Other suitable aqueous fluids may include aqueous mineral acids or aqueous organic acids, such as aqueous solutions of hydrochloric acid, hydrobromic acid, formic acid, acetic acid, propionic acid, methanesulfonic acid, chloroacetic acid (e.g., mono-chloroacetic acid, dichloroacetic acid, and trichloroacetic acid), trifluoroacetic acid, or the like. Any acid may be suitable for use in the disclosure herein may be able to generate a pH of two (2) or lower when present in the compositions in a suitable amount.

Aqueous acid solutions may be combined with any aqueous fluids obtained from any of the other foregoing aqueous fluid sources as well. Suitable aqueous acid solutions may have an acid concentration ranging from 5 wt % to 70 wt %, or 5 wt % to 50 wt %, or 10 wt % to 40 wt %, or 10 wt % to 30 wt %, based on total mass of the aqueous fluid.

Compositions of the present disclosure may maintain stability in acid concentrations greater than 30 wt %, or greater than 28 wt %, or greater than 15 wt %, or 0.1 wt % to 30 wt %, or 10 wt % to 30 wt %, or 0.1 wt % to 35 wt %, or 0.1 wt % to 40 wt %, and under high-temperature conditions including up to 200° F. to 350° F., or 200° F. to 300° F., or 250° F. to 350° F., or even greater than 350° F. for up to 72 hours, or 1 hours to 72 hours, or 6 hours to 72 hours, or 24 hours to 72 hours, or 48 hours to 72 hours, or greater than 72 hours, or 72 hours to 84 hours of contact time.

When present in the compositions (either in emulsified or non-emulsified form), the aqueous fluid may comprise 25 wt % to 85 wt %, or 30 wt % to 80 wt %, or 30 wt % to 50 wt %, or 50 wt % to 70 wt %, or 50 wt % to 80 wt %, or 60 wt % to 80 wt % of the composition, based on total mass of the composition, including the aqueous fluid and the various components discussed above. The aqueous fluid may support emulsion formation by providing a continuous phase for emulsification of immiscible components, such as the oleaginous liquid, for example. The emulsion formed may, thus, define an oil-in-water emulsion. The oleaginous liquid may comprise the “oil” phase of the emulsion and the aqueous fluid may comprise the “water” phase of the emulsion.

When an aqueous fluid is present in the compositions, the other components may be present in the following weight percentage ranges, with each weight percentage being based on total mass of the composition, including the aqueous fluid: 1 wt % to 15 wt % of the oleaginous liquid, 5 wt % to 30 wt % of the fatty alkyl alcohol ethoxylate, 2 wt % to 30 wt % or 5 wt % to 40 wt % of at least one of the fatty alkyl ethoxylated ammonium salt, the zwitterionic surfactant, the alkyl ether sulfate salt, or the alkyl ether sulfonate salt, and 4 wt % to 30 wt % of the co-solvent.

Without being bound by theory, emulsions may be formed due to molecular interactions between the solvents and aqueous fluids present in the compositions. Various surfactants and/or other components supplied as part of the compositions may promote the formation of and/or stabilize the emulsion. The emulsion may be formed by mixing the various components together in an aqueous fluid and agitating to form the emulsion. In non-limiting examples, mixing may be performed in a mixing tank, blender, homogenizer, static mixer, or using any other suitable mixing technique or device known to persons having ordinary skill in the art.

When formed, emulsified compositions of the present disclosure may comprise a microemulsion or a nanoemulsion. As used herein, “microemulsion” refers to an emulsion with particles that generally have an approximate average particle size from 1 μm (micrometers) to 10 μm, while a “nanoemulsion” refers to an emulsion with particles that generally have an approximate average particle size from 10 nm (nanometers) to 10,000 nm, including from 10 nm to 1000 nm. It should be noted that microemulsions and nanoemulsions may refer to the same type of emulsion, depending on the particle size (e.g., in an overlapping size range between 1 μm to 10 μm). Emulsions of the present disclosure may have an average particle size ranging from 50 nm to 5000 nm, or 50 nm to 500 nm, or 100 nm to 500 nm, or 50 nm to 600 nm, or 100 nm to 600 nm, or 500 nm to 1000 nm, or 500 nm to 2000 nm, or 500 nm to 3000 nm, or 1000 nm to 3000 nm, or 1000 nm to 5000 nm. Average particle size in the emulsion may be measured using a particle size analyzer capable of analyzing liquid emulsion particle sizes.

Compositions of the present disclosure comprising an aqueous fluid may exhibit a surface tension, as measured against air, of about 35 mN/m or below, or about 34 mN/m or below, or about 33 mN/m or below, or about 32 mN/m or below, or about 31 mN/m or below, or about 30 mN/m or below, such as about 25 nM/m to about 35 nM/m, or about 31 mN/m to about 27 mN/m, or about 33 mN/m to 30 mN/m.

Compositions comprising an aqueous fluid may define a treatment fluid suitable for performing a subterranean stimulation operation. The term “treatment fluid,” and grammatical variants thereof, refers to any fluid that may be used in a subterranean treatment operation (also referred to simply as “treatment” or “operation” herein) in conjunction with a desired function and/or for a desired purpose. The term “treatment fluid” does not imply any particular action by the fluid or any component thereof. Suitable stimulation operations that may be promoted by a treatment fluid include, but are not limited to, matrix acidizing, fracturing, acid fracturing, or any combination thereof. When formulated in a treatment fluid using the components described above, the components that are not an aqueous fluid may collectively define a “flowback aid” (flowback enhancer) that promotes production of the treatment fluid or a spent variant thereof to the surface following a stimulation operation. The flowback aid may afford advantageous properties during a treatment operation, such as an increase in the volume and/or flow rate of the spent or partially spent treatment fluid to the wellhead during flowback.

Treatment fluids of the present disclosure may be formulated by combining a suitable aqueous acid and other components of a flowback aid described herein over a range of concentrations suitable to perform a desired stimulation operation. The volume concentration of the flowback aid in the aqueous acid may range from 0.5 gpt (gallons per thousand) to 5 gpt, or 2 gpt to 5 gpt, or 1 gpt to 2 gpt, or 2 gpt to 4 gpt, or 2 gpt to 5 gpt, or even greater than 5 gpt.

The treatment fluids described herein may further include one or more additional components suitable for achieving one or more desired functions (e.g., in addition to the stimulation operation in question), provided that the one or more additional components do not adversely affect the function of treatment fluids described herein. Examples of suitable additional components may include, but are not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a proppant, a gravel particulate, a lost circulation material, a foaming agent, a gas, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, an iron control agent, the like, or any combination thereof. Suitable examples of the foregoing will be familiar to one having ordinary skill in the art.

Compositions of the present disclosure may be formulated as a main treatment fluid for introduction to a subterranean formation, or the compositions may be formulated as a pad fluid. As used herein, a “pad fluid” refers to a small-volume treatment fluid that contains at least some of the components present in a main treatment fluid (commonly a larger-volume of main treatment fluid) to follow the pad fluid. For example, during a fracturing operation, a pad fluid comprising all components except for proppant particulates may precede a subsequently introduced fracturing fluid containing proppant particulates. Thus, in the present disclosure, a pad fluid comprising an aqueous acid and a flowback aid comprising a blend of components specified above may precede and acid fracturing fluid comprising the aqueous acid, the flowback aid, and a plurality of proppant particulates.

In some embodiments, the treatment fluids described herein may be foamed. For example, certain treatment fluids described herein may comprise a foamed acid fracturing fluid or a foamed matrix acidizing fluid. A gas component or a foaming agent (a component that forms a gas under specified conditions) may be injected into the treatment fluid in order to form a foam, before flowing the treatment fluid into a subterranean formation as part of a reservoir stimulation operation. Alternately, foam formation may take place downhole. Suitable gases to promote foaming may include, but are not limited to, nitrogen (N₂), carbon dioxide (CO₂), the like, or any combination thereof. Foaming agents may generate these gases or others under the specified conditions. Introduction of the gas or foaming agent into the treatment fluid may be carried out in any suitable means known in the art. Suitable foaming agents will also be familiar to persons having ordinary skill in the art.

In some or other embodiments, treatment fluids of the present disclosure may be gelled or emulsified. Gelled treatment fluids may comprise a polymer to promote gelling, wherein the gel may comprise a linear gel or a crosslinked polymer gel.

Accordingly, treatment methods of the present disclosure may comprise: providing a treatment fluid comprising: an aqueous fluid comprising an aqueous acid selected from the group consisting of a mineral acid, an organic acid, and any combination thereof; 10 wt % to 25 wt % of an oleaginous liquid; 5 wt % to 50 wt % of a fatty alcohol ethoxylate; 15 wt % to 75 wt % of at least one of an ethoxylated ammonium salt, a zwitterionic surfactant, an alkyl ether sulfate salt, or an alkyl ether sulfonate salt; and 5 wt % to 40 wt % of a co-solvent, each wt % being based on a total mass of the treatment fluid, excluding aqueous fluids; and introducing the treatment fluid into a subterranean formation during a stimulation operation. When the aqueous fluid is factored in the wt % calculations, the following amounts of the various components may be present: 1 wt % to 15 wt % of the oleaginous liquid, 5 wt % to 30 wt % of the fatty alcohol ethoxylate, 2 wt % to 30 wt % or 5 wt % to 40 wt % of at least one of the ethoxylated ammonium salt, the zwitterionic surfactant, the alkyl ether sulfate salt, or the alkyl ether sulfonate salt, and 4 wt % to 30 wt % of the co-solvent. The aqueous fluid may be present at 30 wt % to 80 wt %, based on total mass of the treatment fluid. The treatment fluid may be emulsified when introduced into the subterranean formation and may optionally be foamed.

Suitable stimulation operations that may be performed with the treatment fluids may include, for example, fracturing, acid fracturing, matrix acidizing, or any combination thereof. The treatment fluids may also be used in conjunction with scale dissolution operations as well. The treatment fluids of the present disclosure may allow for provision of one or more of the aforementioned functions simultaneously, allowing for a single stage reservoir stimulation operation to be carried out where, conventionally, multiple stages of reservoir stimulation may have been required. No special mixing or equipment requirements are believed to be needed for preparation and use of the treatment fluids described herein.

The stimulation operations may be conducted in a subterranean formation comprising a carbonate reservoir. When performing matrix acidizing upon a carbonate reservoir, the various components of the treatment fluid may slow the reaction of the aqueous acid with the carbonate matrix, thereby encouraging generation of wormholes rather than bulk erosion of the surface of the formation matrix. Whereas wormhole formation may facilitate increased hydrocarbon production, surface erosion generally does not. Thus, during matrix acidizing and acid fracturing operations, the treatment fluids described herein may facilitate use of smaller quantities of acid in conjunction with promoting deeper penetration into the formation matrix. Deeper matrix penetration may occur even when the treatment fluids are in non-emulsified form. The foregoing may decrease treatment and production costs, as well as afford environmental benefits. On-the-fly production of the treatment fluids may occur in some cases, particularly when the treatment fluid is in non-emulsified form.

In some embodiments of the present disclosure the reservoir stimulation operation may comprise matrix acidizing. During the matrix acidizing operation, acid-soluble material in the subterranean formation may be dissolved by the treatment fluid. Injection as part of the matrix acidizing operation may occur while the formation is subjected to pressures lower than the fracture gradient pressure. After at least partial spending of the aqueous acid in the treatment fluid, the other components in the treatment fluid may then aid in the flowback of a heavy brine produced through dissolution of the formation matrix.

In some embodiments of the present disclosure the reservoir stimulation operation may comprise acid fracturing. Acid fracturing comprises fracturing the formation and dissolving acid-soluble material of the formation, wherein the treatment fluid is introduced at a pressure higher than the fracture gradient pressure of the formation in order to simultaneously fracture and dissolve portions of the formation using the treatment fluid. Following fracturing, the other components in the treatment fluid may then aid in the flowback of a heavy brine produced through dissolution of the formation matrix.

In some embodiments, the treatment fluids disclosed herein (including mixing of individual components or mixtures thereof, i.e., within the flowback aid) may be mixed at a remote location from a job site and shipped thereto or, in other embodiments, the treatment fluids may be mixed at a job site. In still other embodiments, the treatment fluid may be mixed and pumped into a subterranean formation on-the-fly. A person having ordinary skill in the art of designing such fluids with the benefit of this disclosure will be able to consider these factors and determine whether remote mixing, on-site mixing, or any other suitable mixing protocol is most appropriate for a given operation. The systems used for handling treatment fluids for use in stimulation operations of the present disclosure may include one or more mixing and/or storage tanks used for mixing and/or storing, respectively, treatment fluids prior to use in a stimulation operation. Additional tanks may be used for storing spent or partially spent treatment fluid removed from a subterranean formation as part of a stimulation operation.

Following a stimulation operation, the treatment fluids or a spent or partially spent variant thereof may be produced from the subterranean formation during aqueous fluid flowback. Advantageously, the fluid recovery from the subterranean formation may be about 50% or greater, or about 60% or greater, or about 70% or greater, or about 80% or greater after being produced from the subterranean formation. Production of the spent or partially spent treatment fluid may take place within 30 minutes, or within about 45 minutes, or within about 60 minutes, or within about 2 hours, or within about 6 hours, or within about 12 hours, or within about 24 hours, depending on the length of time the treatment fluid is shut in downhole to perform the stimulation operation.

Systems for introduction of treatment fluids to a wellbore in conjunction with a stimulation operation may comprise a pump fluidly coupled to a tubing, the tubing located at least partially within the wellbore and the tubing containing a treatment fluid for a desired stimulation operation. The “pump” described herein may comprise a single pump or may comprise one or more pumps which may include “high pressure” and “low pressure” pump(s) in any combination. A “high pressure” pump, i.e., a pump operating at a pressure greater than about 1000 psi, may be used in stimulation operations according to the present disclosure such as acid fracturing where fracturing of the subterranean formation at a pressure higher than the fracture gradient pressure is required. A “low pressure” pump, i.e., a pump operating at a pressure of about 1000 psi or less, may be used in stimulation operations such as matrix acidizing where lower pressures are needed and where fracturing of the subterranean formation is not required. Given the benefit of the present disclosure, one having ordinary skill in the art will be able to select an appropriate pump or combination of pumps for a given stimulation operation.

The treatment fluids of the present disclosure may be injected using the pump(s) into the subterranean formation using the tubing located within the wellbore. The treatment fluid used in a particular stimulation operation may flow downhole through the tubing and flow out of the tubing into the subterranean formation in order to carry out the stimulation operation. Subsequently, in some stimulation operations including matrix acidizing and acid fracturing, the treatment fluid of a particular stimulation operation may be flowed back to the wellhead along with residual components which may include, for example, the acid-soluble material dissolved from the formation matrix during an acidizing operation. The treatment fluid and residual components may flow through the tubing or the wellbore annulus and back to the wellhead.

It should be noted that additional nonlimiting components may be present in systems suitable to introduce the treatment fluids to a subterranean formation and to recover fluid from the subterranean formation following stimulation. Such additional components will be familiar to one having ordinary skill in the art and include, but not limited to, supply hoppers, valves, condensers, adapters, joints, gauges, sensors, compressors, pressure controllers, pressure sensors, flow rate controllers, flow rate sensors, temperature sensors, the like, or any combination thereof.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices, or components, the like, or any combination thereof.

To facilitate a better understanding of the embodiments described herein, the following examples of various representative embodiments are given. In no way should the following examples be read to limit, or to define, the scope of the present disclosure.

### EXAMPLES

Example 1: Formulations. Samples A-F were formulated by combining various blends of surfactants, oleaginous liquids, co-solvents, and water together as indicated in Tables 1-6 below. In general, the sequence of addition was in the order of water, then co-solvent (alcohol), then surfactant(s), and finally oleaginous liquid (solvent). After addition of the water, co-solvent, and surfactant(s), the resulting intermediate blend was mixed for 30 minutes in a blender or until the various components were dissolved together. Subsequently, the oleaginous liquid (Elevance HFS-10 (9-decenoic acid methyl ester) or D-limonene) was added, and the composition was mixed for an additional 10 minutes. A white or milky appearance appeared upon initial mixing in some cases, but upon further mixing, the composition clarified without layer formation or separation. An emulsion is believed to result at this stage.

TABLE 1
Sample A

| Order | Chemical | Quantity (wt %) |
|---|---|---|
| 1 | Deionized Water | 50% |
| 2 | Propylene glycol | 10% |
| 3 | C₆-C₁₀ alkyl ether sulfate ammonium salt | 20% |
| 4 | C₁₁-C₁₅ secondary alcohol ethoxylate, 5-9 EO | 15% |
| | units | |
| 5 | D-Limonene | 5% |

TABLE 2
Sample B

| Order | Chemical | Quantity (wt %) |
|---|---|---|
| 1 | Deionized Water | 45% |
| 2 | Propylene glycol | 10% |
| 3 | C₆-C₁₀ alkyl ether sulfate ammonium salt | 30% |
| 4 | C₁₁-C₁₅ secondary alcohol ethoxylate, 5-9 EO | 10% |
| | units | |
| 5 | D-Limonene | 5% |

TABLE 3
Sample C

| Order | Chemical | Quantity (wt %) |
|---|---|---|
| 1 | Deionized Water | 45% |
| 2 | Propylene glycol | 10% |
| 3 | C₁₂-C₁₄ alkyl dimethyl betaine (100%) | 30% |
| 4 | C₁₁-C₁₅ secondary alcohol ethoxylate, 5-9 EO | 10% |
| | units | |
| 5 | D-Limonene | 5% |

TABLE 4
Sample D

| Order | Chemical | Quantity (wt %) |
|---|---|---|
| 1 | Deionized Water | 40% |
| 2 | Propylene glycol | 10% |
| 3 | C₆-C₁₀ alkyl ether sulfate ammonium salt | 30% |
| 4 | C₁₁-C₁₅ secondary alcohol ethoxylate, 5-9 EO | 15% |
| | units | |
| 5 | D-Limonene | 5% |

TABLE 5
Sample E

| Order | Chemical | Quantity (wt %) |
|---|---|---|
| 1 | Deionized Water | 55% |
| 2 | Propylene glycol | 10% |
| 3 | Alkyl alcohol ethoxylate, 5 EO units | 15% |
| 4 | Alkyl methyl polyoxyethylene ammonium | 15% |
| | chloride, 15 EO units | |
| 5 | D-Limonene | 5% |

TABLE 6
Sample F

| Order | Chemical | Quantity (wt %) |
|---|---|---|
| 1 | Deionized Water | 40% |
| 2 | Propylene glycol | 10% |
| 3 | Alkylamidopropyl amine oxide | 20% |
| 4 | Alkylamidopropyl betaine | 15% |
| 5 | C₁₁-C₁₅ Secondary alcohol ethoxylate, 5-9 EO | 10% |
| | units | |
| 6 | D-Limonene | 5% |

Example 2: Surface Tension Measurements to Determine Stability. The compositions of Example 1 were diluted to 2 gallon per thousand gallons (gpt) or 5 gpt to test stability in acid. The 2 gpt samples were prepared by diluting 0.2 mL of Samples A-F in 100 mL 28% (w/v) HCl, and the 5 gpt samples were prepared by diluting 0.5 mL of Samples A-F in 100 mL 28% (w/v) HCl. Stability was evaluated by measuring the surface tension of the fluid over time, with a rise in surface tension corresponding to instability in acid (visual assessment of stability was also conducted-see Example 3 below). Surface tension values were measured using a Ramé-Hart Model 210 contact angle goniometer. Surface tension values were determined after 24 hours of contact with acid at room temperature)(22° C.). A 28% HCl comparative sample was also tested. Stability testing results of the as-prepared samples are summarized in Table 7 below.

The acidic samples were also evaluated for stability after acid spending at room temperature and at elevated temperatures of 250° F. and 325° F. Each sample was prepared as above, and 38-39 g of calcium carbonate powder was then slowly added with stirring until the pH of the solution reached 3-5 or higher. The pH values were measured using a Hatch pH meter. The surface tension was evaluated at room temperature, immediately after acid spending was complete and after further heating the spent fluid for 24 hours in an oven at 250° F. or 325° F. Heating was conducted in a closed stainless steel pressure cell under nitrogen. The spent fluid testing results are summarized in Table 7 below, and the elevated temperature stability testing results are summarized in Table 8 below.

TABLE 7

| | Surface Tension at 2 gpt (mN/m) | | Surface Tension at 5 gpt (mN/m) | |
|---|---|---|---|---|
| Sample | Fresh 28% HCl | Spent 28% HCl | Fresh 28% HCl | Spent 28% HCl |
| A | 23.16 | 32.23 | 23.00 | 26.98 |
| B | 20.79 | 28.11 | 21.50 | 25.29 |
| C | 23.67 | 27.83 | 21.75 | 25.84 |
| D | 21.78 | 27.77 | 22.81 | 24.07 |
| E | 28.52 | 27.2 | 25.69 | 24.21 |
| F | 25.53 | 30.61 | 24.87 | 25.18 |
| 28% HCl | 62.23 | 64.68 | 62.23 | 64.68 |
| (Comp.) | | | | |

TABLE 8

| | Surface Tension at 2 gpt (mN/m) | |
|---|---|---|
| Sample | Spent HCl, 250° F. for 24 h | Spent HCl, 325° F. for 24 h |
| A | 31.97 | 25.12 |
| B | 25.98 | 28.31 |
| C | 27.95 | 29.76 |
| D | 28.21 | 32.17 |
| E | 27.8 | 29.2 |
| F | 32.3 | 33.5 |

As shown in Tables 7 and 8, the samples exhibited good stability in acid. The increased surface tension following acid spending is believed to result from the dissolved CaCl₂) formed upon neutralization. After heating at 250° F. or 325° F. for 24 hours, the surface tension only changed minimally from the unspent and unheated spent solutions, which attests to the sample stability under the range of testing conditions.

Example 3: Visual Assessment of Stability. The acid-diluted samples from Example 2 (both before and after acid spending) were photographed and evaluated visually for phase separation or precipitation. The pre-spending samples remained clear and colorless, and the spent samples were colorless and clear to lightly cloudy. Phase separation did not occur. Based upon such a visual inspection, the samples were deemed to remain stable and compatible under the testing conditions.

Samples A-F were also diluted to 2 gpt in 2% (w/v) KCl, and stability was evaluated visually in a similar manner. Again, the samples remained clear and colorless with no phase separation indicating instability under the testing conditions.

Example 4: Stability in the Presence of Condensate. 5 mL of heptane was combined with 5 ml of the 2 gpt spent acidizing fluids of Example 2 to mimic condensate contact. The combined mixture was agitated by hand for 5 minutes to form an emulsion and then left at room temperature for 24 hours to allow phase separation to occur. A separate set of samples was prepared similarly but was heated in a water bath for 24 hours. Photographs of the samples were taken over time for visual assessment of the emulsion stability.

Samples A and B each showed loose emulsion in the condensate (heptane layer) after 1 hour and near 100% broken emulsion after 24 hours. Samples C and D showed some initial phase separation after 1 hour with some loose emulsion in the condensate layer. At 24 hours, Sample C showed over 90% separation with some loose emulsion in the condensate layer, while Sample D showed a slight amount of loose emulsion in the condensate layer after 24 hours. The samples (A-F) heated at 150° F. were largely broken after 1 hour of heating, with only minimal loose emulsion remaining at the layer interface in some cases.

Example 5: Emulsion Particle Size Determination. The particle size of emulsified samples was measured by dynamic light scattering using Anton Paar Litesizer 500. Measurements were performed directly on Samples A-F (Example 1) Samples A-F combined with 28% (w/v) HCl at 2 gpt (Example 2), and Samples A-F combined with 2% (w/v) aqueous KCl at 2 gpt (Example 3). Particle size measurements of the emulsions are summarized in Table 9.

TABLE 9

| | Particle Size (nm) | | |
|---|---|---|---|
| Sample | Emulsion Only (Example 1) | 2% KCl (2 gpt) | 28% HCl (2 gpt) |
| A | 176 | 237 | 105 |
| B | 120 | 187 | 140 |
| C | 484 | 507 | 172 |
| D | 277 | 189 | 130 |
| E | 354 | 425 | 274 |
| F | 454 | 802 | 672 |

Example 6: Column Test. Carbonate particle packed columns were used to simulate fluid recovery. A plexiglass column (8.25 inches long×1 inch internal diameter) was loaded with 40 mL of the spent 2 gpt or 5 gpt samples from Example 2. 400 micron calcium carbonate particles were added slowly to the column while mixing using a vortex mixer and introducing additional spent fluid sample by pipette to pack the particles sufficiently. This process was continued until the column was topped off with a flat surface and no air bubbles were visually present within the column. The final amount of calcium carbonate loaded within the column ranged from about 160-170 g, and the final amount of spent fluid sample ranged from about 60-70 mL. Each end of column was capped with a 200 mesh screen to contain fines and prevent plugging of flow lines.

Nitrogen gas was used to apply pressure through the bottom of column to pump out spent aqueous fluid through the top of the column, which was collected. This process was used to mimic reservoir gas in the field forcing the spent fluid through the formation and into the wellbore. A calibrated flow meter was used to verify the flow rate of the spent aqueous fluid before each test. The test was conducted at a gas flow rate of 100 cc/min. An electronic lab balance and weight data collector software was used to record the weight of the spent aqueous fluid collected from the column. Density of the fluid was recorded with a densitometer, and the volume of the spent fluid recovered was calculated from mass values recorded during testing. The baseline fluid recovery from the column was determined using spent 28% (w/v) HCl acidizing fluid as a comparative sample without any of Samples A-F being added.

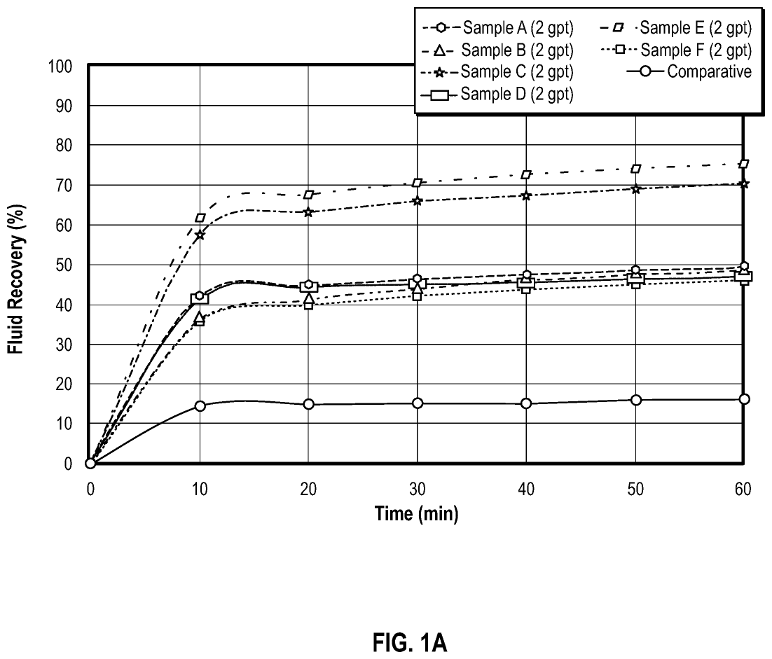

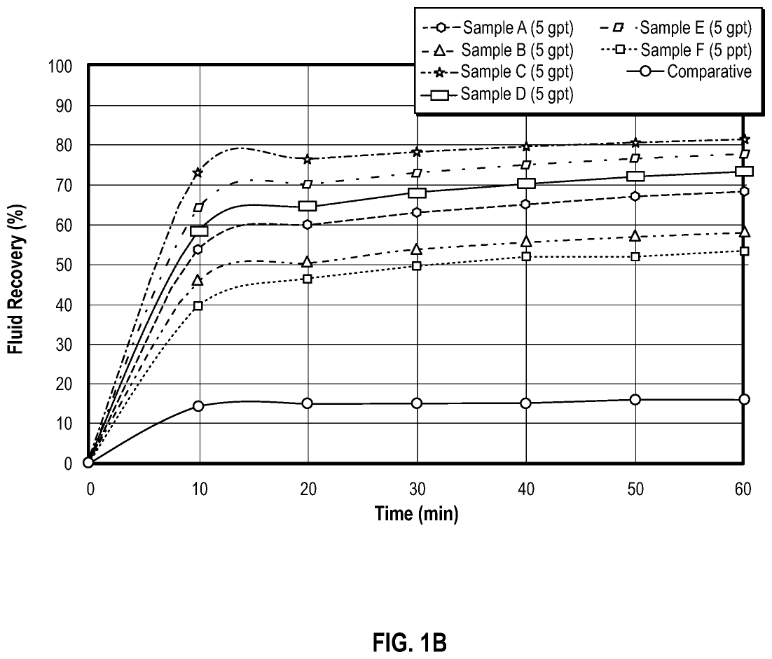

Results from the data collected were used to calculate fluid recovery percentages by dividing the amount of fluid recovered by the amount of fluid initially packed into the column. FIGS. 1A and 1B are graphs of fluid recovery as a function of time for Samples A-F at 2 gpt and 5 gpt, respectively. As shown in FIGS. 1A and 1B, incorporation of Samples A-F within the spent acidizing fluid eased fluid displacement from the column relative to the comparative sample (28% (w/v) HCl). Under the testing conditions, Sample E afforded the greatest fluid recovery at 2 gpt, and Sample C afforded the greatest fluid recovery at 5 gpt.

Example 7: Coreflow Testing. Coreflow tests were performed in a coreflow apparatus using limestone cores having a 12 inch length and 1.5 inch diameter and an average initial permeability to nitrogen gas of 1.5 to 2.4 md (millidarcy).

A dry limestone core was loaded in the coreflow apparatus, and a confining pressure of 4000 psi and back pressure of 3000 psi were applied to the core sample. The coreflow apparatus was heated to a temperature of 300° F., and nitrogen gas was flowed through the system at 2 mL/min to determine the initial core permeability. 0.25 Pore volumes of acidizing fluids prepared from Sample C combined at 2 gpt with either 15% (w/v) HCl or 28% (w/v) HCl were loaded into the coreflow apparatus to avoid breakflow at the 2 mL/min gas flow rate. The core sample was aged for 3 hours at 300° F. in the presence of the acidizing fluid. Nitrogen gas was then injected to the core sample in the reverse direction to recover the injected acidizing fluid and to measure the final permeability. The permeability improvement was compared against 15% or 28% HCl controls (HCl alone) and also against a commercial flowback enhancer (combination of 15% or 28% HCl plus commercial flowback enhancer). Permeability improvement was measured by calculating the ratio (converted to a percentage) of the post-treatment permeability against the pre-treatment permeability. Testing results are shown in Table 10.

TABLE 10

| | Added | | | |
|---|---|---|---|---|
| | Example 1 | | | |
| | Sample or | Initial | Final | % |
| Acidizing | Commercial | Permeability | Permeability | Permeability |
| Fluid | Sample | (md) | (md) | Improvement |
| 15% HCl | None | 1.86 | 3.04 | 63.4 |
| 15% HCl | Commercial | 1.5 | 2.20 | 46.7 |
| | @ 2 gpt | | | |
| 15% HCl | Sample C @ 2 | 2.0 | 4.33 | 116.5 |
| | gpt | | | |
| 28% HCl | None | 2.4 | 2.77 | 15.4 |
| 28% HCl | Commercial | 1.65 | 2.60 | 57.6 |
| | @ 2 gpt | | | |
| 28% HCl | Sample C @ 2 | 2.03 | 7.46 | 267.4 |
| | gpt | | | |

As shown, Sample C improved permeability significantly in comparison to the 15% and 28% HCl controls and the commercial sample.

Embodiments disclosed herein include:
A. Compositions comprising: 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the composition, excluding aqueous fluids.
A1. Treatment fluids comprising an aqueous fluid and the composition of A.
B. Methods for stimulating a subterranean formation, comprising: providing a treatment fluid comprising: an aqueous fluid comprising an aqueous acid selected from the group consisting of a mineral acid, an organic acid, and any combination thereof; 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the treatment fluid, excluding aqueous fluids; and introducing the treatment fluid into a subterranean formation during a stimulation operation.

Each of embodiments A, A1 and B may have one or more of the following additional elements in any combination:
Element 1. wherein the oleaginous liquid comprises a terpene, a hydrocarbon, a fatty acid ester, or any combination thereof.
Element 2. wherein the fatty alkyl alcohol ethoxylate comprises a linear or branched C₆-C₁₈ alcohol ethoxylate comprising 3 to 30 ethoxylate repeat units.
Element 3. wherein the fatty alkyl ethoxylated ammonium salt is present and comprises at least one functionalized alkyl group having 3 to 30 ethoxylate repeat units.
Element 4. wherein the zwitterionic surfactant is present and comprises a C₁₂-C₁₈ betaine, a C₁₂-C₁₈ sultaine, or any combination thereof.
Element 5. wherein the alkyl ether sulfate salt or the alkyl ether sulfonate salt is present and comprises an ammonium salt.
Element 6. wherein the co-solvent comprises an alcohol, a glycol, a glycol ether, a glycol ester, or any combination thereof.
Element 7. wherein the composition comprises: 15 wt % to 20 wt % of the oleaginous liquid; 10 wt % to 40 wt % of the fatty alkyl alcohol ethoxylate; 20 wt % to 60 wt % of at least one of the fatty alkyl ethoxylated ammonium salt, the zwitterionic surfactant, the alkyl ether sulfate salt or the alkyl ether sulfonate salt; and 10 wt % to 30 wt % of the co-solvent.
Element 8. wherein the composition further comprises an aqueous fluid.
Element 9. wherein the composition comprises 25 wt % to 85 wt % of the aqueous fluid, based on the total mass of the composition, including the aqueous fluid.
Element 10. wherein the composition is emulsified to form an emulsion.
Element 11. wherein the emulsion has a particle size of 50 nm to 5000 nm.
Element 12. wherein the aqueous fluid comprises an aqueous acid selected from the group consisting of a mineral acid, an organic acid, and any combination thereof.
Element 13. wherein the aqueous acid has a concentration of 5 wt % to 70 wt %.
Element 14. wherein the aqueous acid has a concentration of 10 wt % to 30 wt %.
Element 15. wherein the composition has a surface tension of 31 mN/m or less, as
measured relative to air.
Element 16. wherein the treatment fluid is foamed.
Element 17. wherein the treatment fluid is emulsified.
Element 18. wherein the stimulation operation comprises matrix acidizing or acid fracturing.
Element 19. wherein the subterranean formation comprises a carbonate reservoir.
Element 20. wherein a recovery of the treatment fluid or a spent variant of the treatment fluid from the subterranean formation is 50% or greater after a shut in period in the subterranean formation.
Element 21. wherein the treatment fluid comprises: 15 wt % to 20 wt % of the oleaginous liquid; 10 wt % to 40 wt % of the fatty alkyl alcohol ethoxylate; 20 wt % to 60 wt % of at least one of the fatty alkyl ethoxylated ammonium salt, the zwitterionic surfactant, the alkyl ether sulfate salt, or the alkyl ether sulfonate salt; and 10 wt % to 30 wt % of the co-solvent.
Element 22. wherein the treatment fluid comprises 25 wt % to 85 wt % of the aqueous fluid, based on the total mass of the treatment fluid, including the aqueous fluid.

By way of non-limiting example, exemplary combinations applicable to A, A1, and B include, but are not limited to: 1 and/or 2, and 3; 1 and/or 2, and 4; 1 and/or 2, and 5; 1 and/or 2, and 6; 1 and/or 2, and 7; 1 and/or 2, and 8; 1 and/or 2, and 8 and 9; 1 and/or 2, and 8 and 10; 1 and/or 2, and 8-10; 1 and/or 2, and 8 and 11; 1 and/or 2, and 8 and 12; 1 and/or 2, and 8, 9, and 12; 1 and/or 2, and 8-10, and 12; 3, 4, or 5, and 6; 3, 4, or 5, and 7; 3, 4, or 5, and 8; 3, 4, or 5, and 8 and 9; 3, 4, or 5, and 8 and 10; 3, 4, or 5, and 8-10; 3, 4, or 5, and 8 and 11; 3, 4, or 5, and 8 and 12; 3, 4, or 5, and 8, 9, and 12; 3, 4, or 5, and 8-10 and 12; 6 and 7; 6 and 8; 6, 8, and 9; 6, 8, and 10; 6, and 8-10; 6, 8, and 11; 6, 8, and 12; 6, 8, 9, and 12; 6, 8-10, and 12; 7 and 8; 7-9; 7, 8, and 10; 7, and 8-10; 7, 8, and 11; 7, 8, and 12; 7, 8, 9, and 12; 7, 8-10, and 12; 8 and 9; 8-10; 8 and 11; 8 and 12; 8, 9, and 12, and 8-10, and 12. With respect to B, any of the foregoing or any one of 1-17 may be in further combination with any one of 18-22; 16 or 17, and 18; 16 or 17, and 19; or 16 or 17, and 18 and 19. Additional exemplary combinations applicable to B include, but are not limited to, 16 or 17, and 18; 16 or 17, and 19; or 16 or 17, and 18 and 19.

The present disclosure is further directed to the following non-limiting clauses.

Clause 1. A composition comprising: 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the composition, excluding aqueous fluids.

Clause 2. The composition of clause 1, wherein the oleaginous liquid comprises a terpene, a hydrocarbon, a fatty acid ester, or any combination thereof.

Clause 3. The composition of clause 1 or clause 2, wherein the fatty alkyl alcohol ethoxylate comprises a linear or branched C₆-C₁₈ alcohol ethoxylate comprising 3 to 30 ethoxylate repeat units.

Clause 4. The composition of any one of clauses 1-3, wherein the fatty alkyl ethoxylated ammonium salt is present and comprises at least one functionalized alkyl group having 3 to 30 ethoxylate repeat units.

Clause 5. The composition of any one of clauses 1-4, wherein the zwitterionic surfactant is present and comprises a C₁₂-C₁₈ betaine, a C₁₂-C₁₈ sultaine, or any combination thereof.

Clause 6. The composition of any one of clauses 1-5, wherein the alkyl ether sulfate salt or the alkyl ether sulfonate salt is present and comprises an ammonium salt.

Clause 7. The composition of any one of clauses 1-6, wherein the co-solvent comprises an alcohol, a glycol, a glycol ether, a glycol ester, or any combination thereof.

Clause 8. The composition of any one of clauses 1-7, wherein the composition comprises: 15 wt % to 20 wt % of the oleaginous liquid; 10 wt % to 40 wt % of the fatty alkyl alcohol ethoxylate; 20 wt % to 60 wt % of at least one of the fatty alkyl ethoxylated ammonium salt, the zwitterionic surfactant, the alkyl ether sulfate salt or the alkyl ether sulfonate salt; and 10 wt % to 30 wt % of the co-solvent.

Clause 9. The composition of any one of clauses 1-8, further comprising:
an aqueous fluid.

Clause 10. The composition of clause 9, wherein the composition comprises 25 wt % to 85 wt % of the aqueous fluid, based on the total mass of the composition, including the aqueous fluid.

Clause 11. The composition of clause 9 or clause 10, wherein the composition is emulsified to form an emulsion.

Clause 12. The composition of clause 11, wherein the emulsion has a particle size of 50 nm to 5000 nm.

Clause 13. The composition of any one of clauses 9-12, wherein the aqueous fluid comprises an aqueous acid selected from the group consisting of a mineral acid, an organic acid, and any combination thereof.

Clause 14. The composition of clause 13, wherein the aqueous acid has a concentration of 5 wt % to 70 wt %.

Clause 15. The composition of clause 13, wherein the aqueous acid has a concentration of 10 wt % to 30 wt %.

Clause 16. The composition of any one of clauses 9-15, wherein the composition exhibits a surface tension of 31 mN/m or less, as measured relative to air.

Clause 17. A treatment fluid comprising the composition of any one of clauses 9-16.

Clause 18. The treatment fluid of clause 17, wherein the treatment fluid is foamed.

Clause 19. A method comprising: providing a treatment fluid comprising: an aqueous fluid comprising an aqueous acid selected from the group consisting of a mineral acid, an organic acid, and any combination thereof; 10 wt % to 25 wt % of an oleaginous liquid; 5 wt % to 50 wt % of a fatty alkyl alcohol ethoxylate; 15 wt % to 75 wt % of at least one of a fatty alkyl ethoxylated ammonium salt, a zwitterionic surfactant, an alkyl ether sulfate salt or an alkyl ether sulfonate salt; and 5 wt % to 40 wt % of a co-solvent, each wt % being based on a total mass of the treatment fluid, excluding aqueous fluids; and introducing the treatment fluid into a subterranean formation during a stimulation operation.

Clause 20. The method of clause 19, wherein the stimulation operation comprises matrix acidizing or acid fracturing.

Clause 21. The method of clause 19 or clause 20, wherein the subterranean formation comprises a carbonate reservoir.

Clause 22. The method of any one of clauses 19-21, wherein a recovery of the treatment fluid or a spent variant of the treatment fluid from the subterranean formation is 50% or greater after a shut in period in the subterranean formation.

Clause 23. The method of any one of clauses 19-22, wherein the oleaginous liquid comprises a terpene, a hydrocarbon, a fatty acid ester, or any combination thereof.

Clause 24. The method of any one of clauses 19-23, wherein the fatty alkyl alcohol ethoxylate comprises a linear or branched C₆-C₁₈ alcohol ethoxylate comprising 3 to 30 ethoxylate repeat units.

Clause 25. The method of any one of clauses 19-24, wherein the fatty alkyl ethoxylated ammonium salt is present and comprises at least one functionalized alkyl group having 3 to 30 ethoxylate repeat units.

Clause 26. The method of any one of clauses 19-25, wherein the zwitterionic surfactant is present and comprises a C₁₂-C₁₈ betaine, a C₁₂-C₁₈ sultaine, or any combination thereof.

Clause 27. The method of any one of clauses 19-26, wherein the alkyl ether sulfate salt or the alkyl ether sulfonate salt is present and comprises an ammonium salt.

Clause 28. The method of any one of clauses 19-27, wherein the co-solvent comprises an alcohol, a glycol, a glycol ether, a glycol ester, or any combination thereof.

Clause 29. The method of any one of clauses 19-28, wherein the treatment fluid comprises: 15 wt % to 20 wt % of the oleaginous liquid; 10 wt % to 40 wt % of the fatty alkyl alcohol ethoxylate; 20 wt % to 60 wt % of at least one of the fatty alkyl ethoxylated ammonium salt, the zwitterionic surfactant, the alkyl ether sulfate salt, or the alkyl ether sulfonate salt; and 10 wt % to 30 wt % of the co-solvent.

Clause 30. The method of any one of clauses 19-29, wherein the treatment fluid comprises 25 wt % to 85 wt % of the aqueous fluid, based on the total mass of the treatment fluid, including the aqueous fluid.

Clause 31. The method of any one of clauses 19-30, wherein the treatment fluid is emulsified or foamed.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1. A composition comprising:
1 wt % to 15 wt % of an oleaginous liquid;
5 wt % to 30 wt % of a fatty alkyl alcohol ethoxylate;
wherein a fatty alcohol of the fatty alkyl alcohol ethoxylate comprises a secondary alcohol;
2 wt % to 30 wt % of at least one of a fatty alkyl ethoxylated ammonium salt, a zwitterionic surfactant, an alkyl ether sulfate salt or an alkyl ether sulfonate salt; and
4 wt % to 30 wt % of a co-solvent, each wt % being based on a total mass of an aqueous fluid.

2. The composition of claim 1, wherein the oleaginous liquid comprises a terpene, a hydrocarbon, a fatty acid ester, or any combination thereof.

3. The composition of claim 1, wherein the fatty alkyl alcohol ethoxylate comprises a linear or branched C₆-C₁₈ alcohol ethoxylate comprising 3 to 30 ethoxylate repeat units.

4. The composition of claim 1, wherein the fatty alkyl ethoxylated ammonium salt is present and comprises at least one functionalized alkyl group having 3 to 30 ethoxylate repeat units.

5. The composition of claim 1, wherein the zwitterionic surfactant is present and comprises a C₁₂-C₁₈ betaine, a C₁₂-C₁₈ sultaine, or any combination thereof.

6. The composition of claim 1, wherein the alkyl ether sulfate salt or the alkyl ether sulfonate salt is present and comprises an ammonium salt.

7. The composition of claim 1, wherein the co-solvent comprises an alcohol, a glycol, a glycol ether, a glycol ester, or any combination thereof.

8. (canceled)

9. (canceled)

10. The composition of claim 8, wherein the composition is emulsified to form an emulsion.

11. The composition of claim 10, wherein the emulsion has a particle size of 50 nm to 5000 nm.

12. The composition of claim 8, wherein the aqueous fluid comprises an aqueous acid selected from the group consisting of a mineral acid, an organic acid, and any combination thereof.

13. The composition of claim 8, wherein the composition exhibits a surface tension of 31 mN/m or less, as measured relative to air.

14. A method comprising:
providing a treatment fluid comprising:
an aqueous fluid comprising an aqueous acid selected from the group consisting of a mineral acid, an organic acid, and any combination thereof;
1 wt % to 15 wt % of an oleaginous liquid;
5 wt % to 30 wt % of a fatty alkyl alcohol ethoxylate;
wherein a fatty alcohol of the fatty alkyl alcohol ethoxylate comprises a secondary alcohol;
2 wt % to 30 wt % of at least one of a fatty alkyl ethoxylated ammonium salt, a zwitterionic surfactant, an alkyl ether sulfate salt or an alkyl ether sulfonate salt; and
4 wt % to 30 wt % of a co-solvent, each wt % being based on a total mass of an aqueous fluid; and
introducing the treatment fluid into a subterranean formation during a stimulation operation.

15. The method of claim 14, wherein the stimulation operation comprises matrix acidizing or acid fracturing.

16. The method of claim 14, wherein the subterranean formation comprises a carbonate reservoir.

17. The method of claim 14, wherein a recovery of the treatment fluid or a spent variant of the treatment fluid from the subterranean formation is 50% or greater after a shut in period in the subterranean formation.

18. The method of claim 14, wherein the oleaginous liquid comprises a terpene, a hydrocarbon, a fatty acid ester, or any combination thereof.

19. The method of claim 14, wherein the fatty alkyl alcohol ethoxylate comprises a linear or branched C₆-C₁₈ alcohol ethoxylate comprising 3 to 30 ethoxylate repeat units.

20. The method of claim 14, wherein the fatty alkyl ethoxylated ammonium salt is present and comprises at least one functionalized alkyl group having 3 to 30 ethoxylate repeat units.

21. The method of claim 14, wherein the zwitterionic surfactant is present and comprises a C₁₂-C₁₈ betaine, a C₁₂-C₁₈ sultaine, or any combination thereof.

22. The method of claim 14, wherein the alkyl ether sulfate salt or the alkyl ether sulfonate salt is present and comprises an ammonium salt.

23. The method of claim 14, wherein the co-solvent comprises an alcohol, a glycol, a glycol ether, a glycol ester, or any combination thereof.

24. The method of claim 14, wherein the treatment fluid comprises 25 wt % to 85 wt % of the aqueous fluid, based on the total mass of the treatment fluid, including the aqueous fluid.

25. The method of claim 14, wherein the treatment fluid is emulsified or foamed.
